(19) United States
(12) Patent Application Publication
(10) Pub. No.: US 2012/0195517 A1
(43) Pub. Date: Aug. 2, 2012

(54) SYSTEM AND METHOD FOR DISTORTING A CLOCKFACE FOR CAPTCHA VALIDATION

(75) Inventors: Shyam Mittur, San Ramon, CA (US); Keiko Horiguchi, Palo Alto, CA (US)

(73) Assignee: Yahoo! Inc., Sunnyvale, CA (US)

(21) Appl. No.: 13/016,971

(22) Filed: Jan. 29, 2011

(51) Int. Cl. G06K 9/40

(52) U.S. Cl. 382/254

(57) ABSTRACT

A system and method of generating a challenge/response test to determine if a computer user is human provides the following steps performed for each instance of the challenge/response test: selecting a graphical image representing an analog clock face with an indicated time; storing the indicated time; applying a distortion filter to the graphical image to generate a distorted graphical image; presenting the distorted graphical image to the computer user with a challenge to identify the indicated time; receiving input from the computer user; and comparing the input to the stored indicated time to determine if the computer user is human.

### CROSS-REFERENCE TO RELATED APPLICATIONS

This application contains subject matter related to subject matter in commonly-owned, co-pending United States Patent Application Publication No. 2010/0077210 A1, entitled “CAPTCHA Image Generation” and filed on Sep. 24, 2008.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of human versus computer validation and more particularly relates to the field of distorting a clock face to aid in CAPTCHA validation.

### BACKGROUND OF THE INVENTION

On-line misuse and abuse is defined by the excessive usage and/or undesirable content of web-based products and services that are intended for use by human computer users. This abuse is generally perpetuated by malicious computer programs or robots (“bots”). Some of the observed abuses are: comment spam in Blogs, pernicious website registration, manipulation of online polls, and dictionary attacks on login, to name a few. Many web-based products and services are used by bots or professional paid users (cheap labor) in an abusive manner.

To address this problem, various implementations of a reverse Turing test are used to protect websites that allow user interaction. The reverse Turing test generally takes the form of a “CAPTCHA” implementation of a challenge/response protocol. The term CAPTCHA is short for “Completely Automatic Public Turing Test to Tell Computers and Humans Apart.” CAPTCHA is a pattern recognition challenge (test) that a human can easily pass, but is difficult or impossible for a computer to pass. For example, humans are able to read distorted text, but computers cannot.

FIG. 1 shows an exemplary textual CAPTCHA provided by Yahoo!®. This CAPTCHA presents a distorted image of the text “smwm.” Even though this word is distorted, it is still relatively easy for a human to discern. A computer, however, has difficulty discerning the distorted text. Recent concerted efforts in software development have reduced the efficacy of these current techniques.

### SUMMARY OF THE INVENTION

Briefly, we describe a computer-implemented method of generating a challenge/response test to determine if a computer user is human. The method includes the following steps or acts performed for each instance of the challenge/response test: selecting a graphical image representing an analog clock face with an indicated time; storing the indicated time; applying a distortion filter to the graphical image to generate a distorted graphical image; presenting the distorted graphical image to the computer user with a challenge to identify the indicated time; receiving input from the computer user; and comparing the input to the stored indicated time to determine if the computer user is human.

In another embodiment of the present invention, a computer system is configured to provide the method steps as described above. The computer system includes at least: a memory storing instructions; and at least one processor device executing the instructions stored in the memory.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is an example of a textual CAPTCHA image, according to the known art;

FIG. 2 is an illustration of a distorted clock face, according to an embodiment of the present invention;

FIG. 3 is a second illustration of a distorted clock face showing a second hand, according to an embodiment of the present invention;

FIG. 4 is a third illustration of a distorted clock face, according to an embodiment of the present invention;

FIG. 5 is a fourth illustration of a distorted clock face, according to an embodiment of the present invention;

FIG. 6 is an example showing how the distorted clock face is used as a CAPTCHA, according to an embodiment of the present invention;

FIG. 7 is an example of the CAPTCHA of FIG. 6, with the correct response input by the user, according to an embodiment of the present invention;

FIG. 8 is a high-level block diagram of a computer system configured to operate according to an embodiment of the present invention;

FIG. 9 is a high-level flow chart of a method for providing a clock face CAPTCHA, according to an embodiment of the present invention;

FIG. 10 is an example of a distorted clock face with Arabic numerals, according to an embodiment of the present invention;

FIG. 11 is an example of a distorted clock face with Arabic numerals, according to another embodiment of the present invention;

FIGS. 12A and 12B provide examples of a distorted clock face with no numeric markings, according to an embodiment of the present invention; and

FIG. 13 is an example of a distorted clock face with no numeric markings and a notch representing the twelfth hour, according to another embodiment of the present invention;

FIGS. 14A, 14B and 14C provide an example of dual distorted clock faces, according to another embodiment of the present invention;

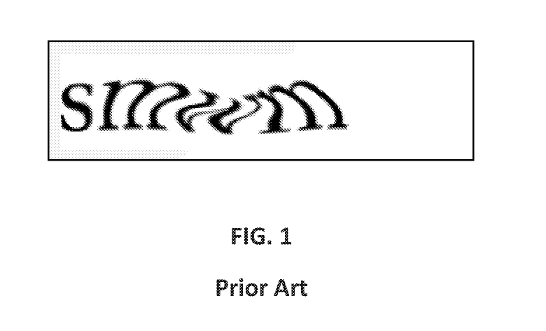

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a novel implementation of a reverse Turing test that presents a distorted image of an analog clock face showing an indicated time. The distorted clock face is presented as part of an image-based challenge/response test that only a human can pass. Unlike known textual-based CAPTCHAs, the time on the clock-face is easily identified by a human computer user, irrespective of the human's language skills. A computer, however, is unable to interpret the image as an analog clock because of the distortion.

This invention leverages a capability to tell time from an analog clock face that is universally present in human users. The challenge is immediately obvious, and does not need extensive instruction. The infinitely large number of presentable variables makes the challenge difficult if not impossible to solve for automated software. Further, adding time-sequenced animation and intermediate steps reduce the incentive for commercial labor outsourcing.

In one embodiment of the present invention, the clock face includes distorted numeric time markings. In other embodiments, the clock face does not present numeric time markings or any time markings at all. For example, Roman numerals can be used in place of numbers, especially since Roman numerals are recognizable by people of many different cultures. An analog clock face can be presented with icons (such as dots or slots) instead of numbers, with the icon corresponding to “12” shown as larger than the other icons.

In the challenge/response according to the invention, the user is prompted to enter the time indicated by the hands of the clock. Correct entry (with tolerance for imprecision) indicates a human user. An incorrect response or invalid response indicates an attempt by automated software. Refinements are incorporated to further deter professional human solvers by adding time-sequenced animation or time-consuming manual steps that must be executed prior to the prompt to enter time becoming visible. Examples of such manual steps are: 1) click and drag on a highlighted corner of the clock face to expand the view and make the clock face larger when the indicated time will be readable; and 2) click on the clock face to initiate an animated display that takes a predetermined but randomly selected amount of time. At the conclusion of the animation, the indicated time will be readable.

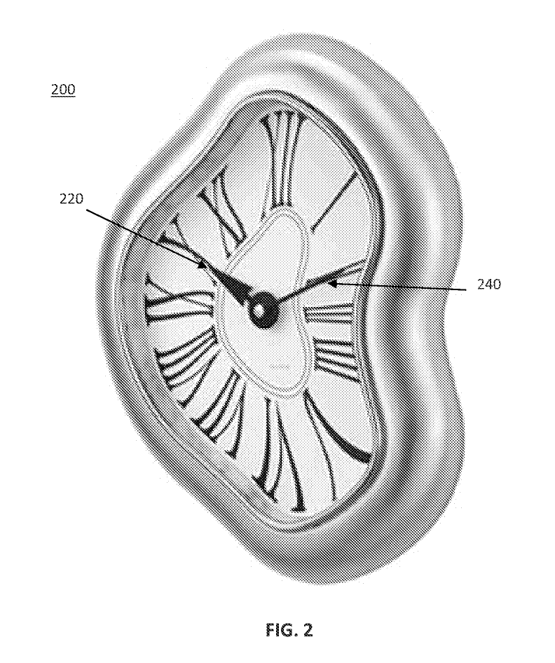

Referring to FIG. 2 there is shown an exemplary embodiment of an analog clock face 200 distorted according to the invention and used to discern human vs. bot interaction. The clock face 200 shown here does not include numeric time markings in the form of Arabic numerals; instead it uses Roman numerals representing the hours from one through twelve. Although the clock face 200 is distorted, a human can recognize that the hour hand 220 is pointing at the number ten (shown here as a Roman numeral X) and that the minute hand 240 is pointing at the two (Roman numeral II). A human recognizes this as 10:10 o'clock.

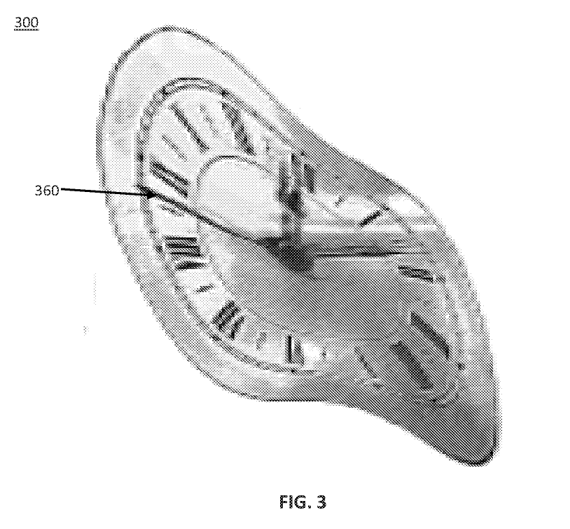

FIG. 3 shows an example of a distorted clock face 300 with a second hand 360.

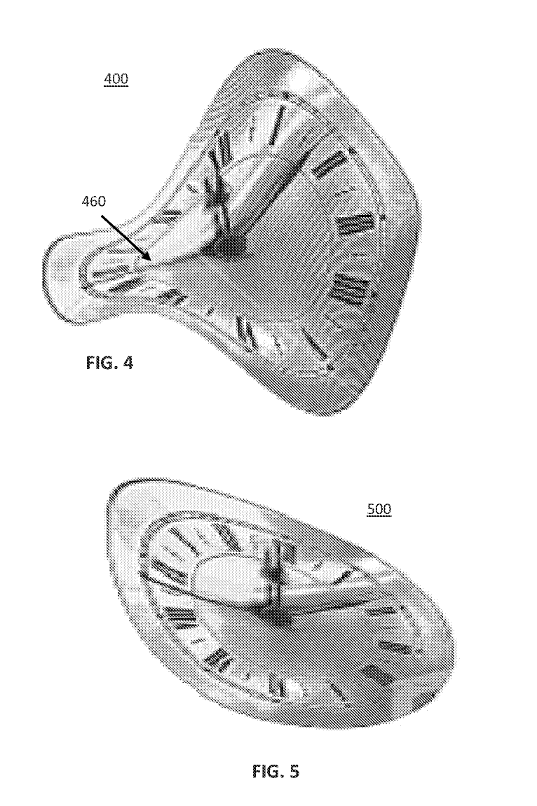

FIG. 4 shows another distorted clock face 400 with a second hand 460. FIG. 5 shows an example of a distorted clock face 500.

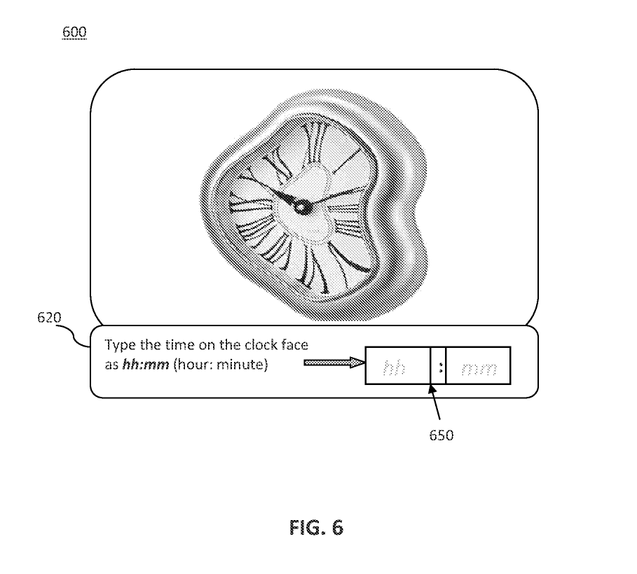

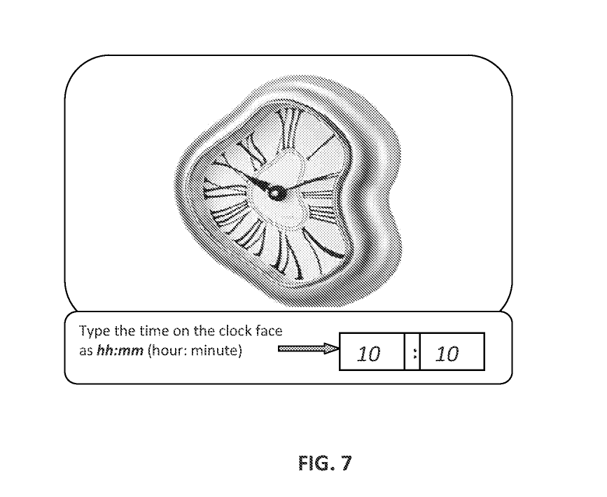

FIG. 6 shows an example of the distorted clock face 200 of FIG. 2 implemented within a challenge/response 600. The challenge/response 600 employs the standard challenge/response protocol wherein a challenge 620 is presented to a computer user and the computer user must supply a response to the challenge in the designated input box 650. A correct response, as shown in FIG. 7, will authenticate the computer user as a human and allow the computer user to proceed to the desired web service or web product.

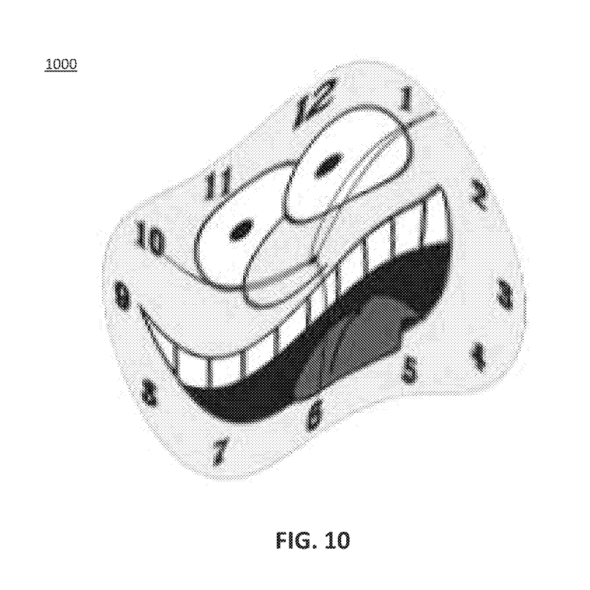

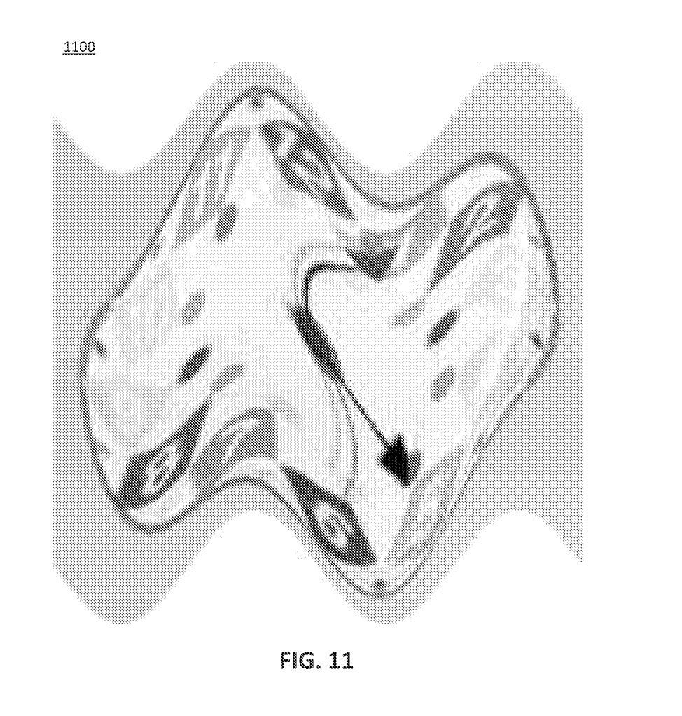

FIGS. 10 and 11 provide two examples of distorted clock faces using Arabic numerals instead of Roman numerals, according to a further embodiment of the present invention. The distorted clock face 1000 of FIG. 10 also shows how the image can be further enhanced to make it more difficult for a computer to discern. FIG. 10 shows a smiley cartoon image on a clock face 1000 showing the time of 10:07. FIG. 11 shows a distorted clock face 1100 enhanced with a colorful confetti design (note that only black and white is shown here) displaying a time of 1:25.

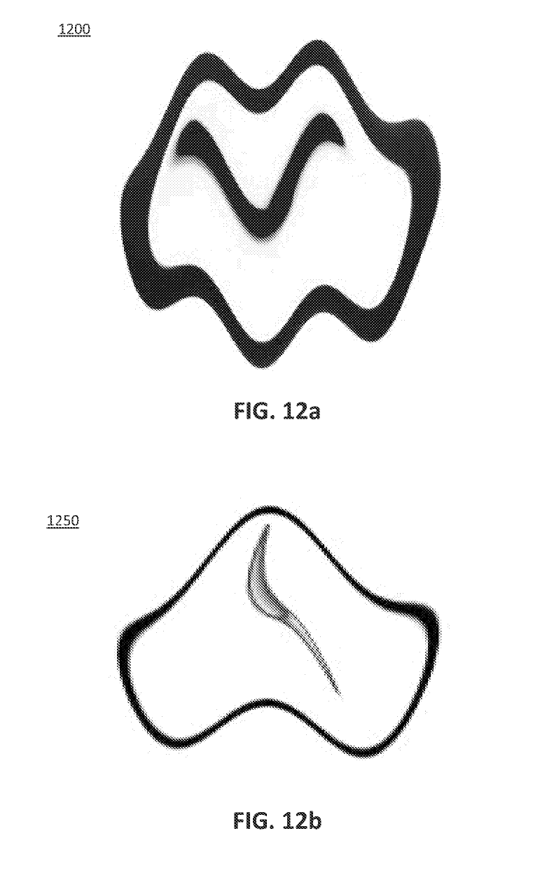

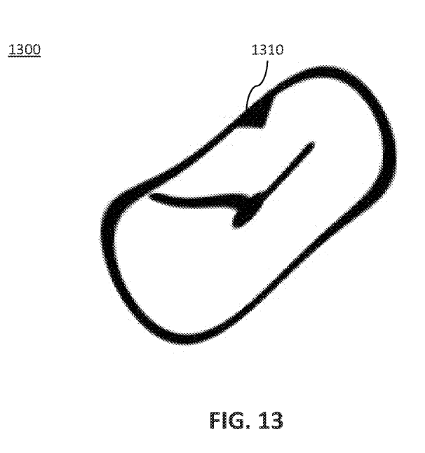

FIGS. 12A, 12B and 13 provide examples of a CAPTCHA using a clock face with no numeric markings, according to an embodiment of the present invention. Even though no numerals are shown, a human user, unlike a computer, is able to discern the time shown on the clock face. FIG. 12A shows a clock face 1200 with the hands at the 10:10 position. FIG. 12B also shows another clock face 1250 with no numeric markings The hands of the clock face of FIG. 12B are displayed at approximately the 5:00 o'clock position. FIG. 13 shows a distorted clock face 1300 with a notch 1310 in the shape of an inverted triangle designating the 12:00 o'clock position on the clock. The “hands” here reflect a time of 1:50 o'clock.

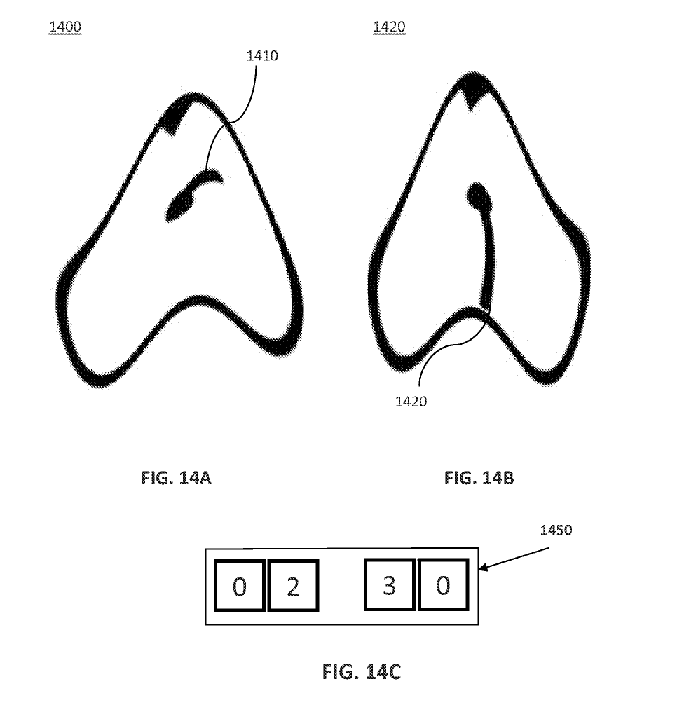

FIGS. 14A, 14B and 14C provide another exemplary embodiment wherein two separate distorted clock faces are displayed. The first clock face 1400 displays the hour hand 1410 which in this example points to 2:00 o'clock. The second clock face 1420 displays the minute hand 1420 which in this example points to half past the hour. The user is able to see both clock faces and discern that the combination of the two clocks provides a time of 2:30 o'clock. The user then inputs the hour designated by the hour hand 1410 and the minute designated by the minute hand 1420 into the input box 1450 shown at 14C.

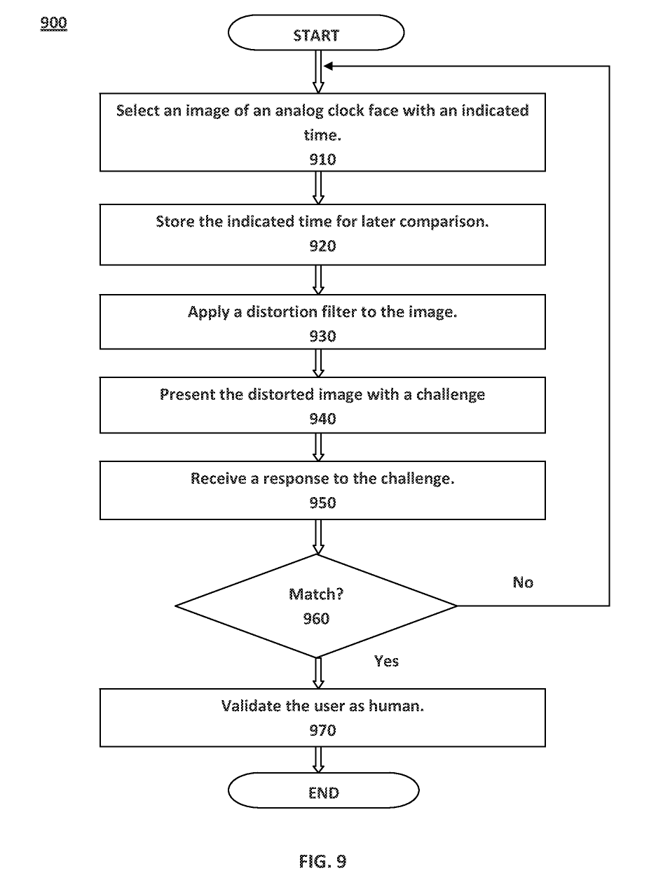

Referring now to the flow chart 900 of FIG. 9, we discuss the method steps for implementing the clock face CAPTCHA according to an embodiment of the present invention. The process begins at step 901 wherein a graphical image of an analog clock face is selected from among a plurality of clock faces. Each of the plurality of clock faces is associated with, and shows, an indicated time of day. Next, in step 920, the indicated time associated with the selected clock face is stored for later comparison. In step 930 a series of mathematical transformations is applied to the image to distort the clock face such that it cannot be recognized by a computer.

In step 940 the distorted image of the clock face is presented along with a challenge requesting that the computer user identify the time indicated on the clock face. The response input by the computer user is received in step 950 and compared in step 960 to determine if the response matches the stored time. If the response matches, then in step 970, the computer user is validated as a human. If, however, the response does not match, the process loops back to step 910 wherein another analog clock face is selected for presentation.

The clock face CAPTCHA implementation offers advantages over known CAPTCHAS because it works well regardless of language and/or culture differences. Virtually all computer users know how to tell time using an analog clock. This ability is consistent across the vast variety of clock face styles used in commercial timepiece designs. People are accustomed to telling time on clock faces that are round, rectangular, oval-shaped, and so forth. This allows the clock face CAPTCHA technique to use a variety of clock face designs to generate a base image representation of a clock face with time indicated. It then applies a series of mathematical transformations to distort the image of the clock face to something that is different with each instance of the challenge that is presented. The distorted image is irreversible (the original image cannot be reconstructed) and no longer represents a symmetric geometrical shape like a circle, oval or rectangle. Thus, it will be difficult for automated software to examine the image as presented and detect the time that is indicated.

Through the additional use of time-sequenced animation and intermediate validation steps, a required time delay will be required to get to a final indicated time. When the display is first invoked a fuzzy image will be displayed, with some animation (a spinning disk is one example). The animation continues for a predetermined but random time interval. At the end of the animation, a discernible clock face with indicated time will be displayed. This is expected to disrupt the economics of commercial paid human labor that is currently used by abusers to outsource the solving of such challenges.

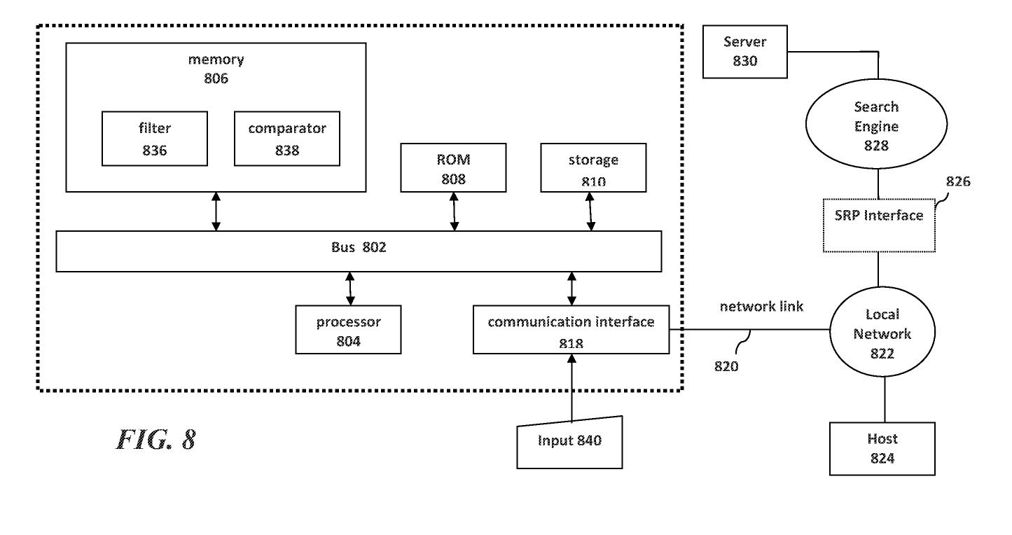

Referring now to FIG. 8 there is shown a high-level block diagram illustrating an information processing system 800 upon which an embodiment of the present invention may be implemented. System 800 includes a bus 802 or other communication mechanism for communicating information, and one or more processors, such as processor device 804 coupled with bus 802 for processing information. System 800 also includes a main memory 806, such as a random access memory (RAM) or other dynamic storage device, coupled with bus 802 for storing information and instructions to be executed by processor device 804 for carrying out the steps in the flow chart of FIG. 9.

Memory 806 stores logic for performing the method steps discussed with respect to FIG. 9. The distortion filter 836 embodies the logic for applying the series of mathematical operations that transform the analog clock face. The comparator 838 embodies the logic for comparing the response input by the computer user to the stored time.

Main memory 806 also may be used for storing temporary variables or other intermediate information during execution of instructions to be executed by process device 804. System 800 further includes, inter alia, a read only (ROM) memory 808 or other static storage device, coupled with bus 802 for storing static information and instructions for processor device 804. A storage device 810, such as a magnetic disk or optical disk, is provided and coupled with bus 802 for storing information and instructions. The storage 810 stores the indicated time from the clock face provided with each instance of the challenge.

In an embodiment of the present invention, computer system 800 is used for implementing a search engine (or search engines) to produce optimized search results through embedded mouse gestures or alternate input actions. According to one embodiment of the invention, the analog clock face CAPTCHA is provided by system 800 in response to processor device 804 executing one or more sequences of one or more instructions contained in memory 806.

System 800 also includes a communication interface 818 providing a two-way communication coupling with a network link 820 that is connected to a local network 822. Examples of a communications interface 818 may include a modem, a network interface (such as an Ethernet card), a communications port, a PCMCIA slot and card, etc. Software and data transferred via communications interface 818 are in the form of signals which may be, for example, electronic, electromagnetic, optical, or other signals capable of being received by communications interface 818. These signals are provided to communications interface 818 via a communications path (i.e., channel). The communications interface 818 further is enabled to receive input 840 from the computer user in response to the challenge provided with the distorted clock face.

Network link 820 typically provides data communication through one or more networks to other devices. Network link 820 may provide a connection through local network 822 to a host computer 824 or to a web browser providing access, through the Internet to a Search Engine 828. According to an embodiment of the present invention, an SRP interface 826 is a layer between the user and the Search Engine 828, providing support for the receipt and processing of the mouse gestures or alternate inputs.

It is to be understood, that the examples given in FIGS. 2 through 8 are just an illustration of the general working of the present invention and that only features relevant for the understanding of it are shown. Numerous specific details have been set forth by way of exemplary embodiments in order to provide a more thorough description of the present invention. It will be apparent, however, to one skilled in the art, that the present invention may be practiced without these specific details. In other instances, well-known features have not been described in detail so as not to obscure the invention. The preferred embodiments of the inventions are described herein in the Detailed Description, Figures and Claims. Unless specifically noted, it is intended that the words and phrases in the specification and claims be given the ordinary and accustomed meaning as understood by those of skill in the applicable art. If any other meaning is intended, the specification will specifically state that a special meaning is being applied to a word or phrase.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A computer-implemented method for generating a challenge/response test to determine if a computer user is a human, said method comprising steps of:
for each instance of the challenge/response test:
using a processor device configured to perform:
selecting a graphical image representing an analog clock face with an indicated time;
storing the indicated time;
applying a distortion filter to the selected graphical image to generate a distorted graphical image;
using an input/output interface configured to perform:
presenting the distorted graphical image to the computer user with a challenge to identify the indicated time; and
receiving input from the computer user; and
using the processor device to compare the input to the stored indicated time to determine if the computer user is human.

2. The computer-implemented method of claim 1, further comprising:
repeating the selecting, storing, applying, presenting, receiving, and comparing steps when the input does not match the stored indicated time.

3. The computer-implemented method of claim 1, further comprising:
validating the computer user as human when the input matches the stored indicated time.

4. The computer-implemented method of claim 1 wherein selecting the graphical image comprises selecting the graphical image of the clock face wherein the indicated time is represented by clock hands pointing to Roman numerals.

5. The computer-implemented method of claim 1 wherein selecting the graphical image comprises selecting the graphical image of the clock face wherein the indicated time is represented by clock hands pointing to Arabic numerals.

6. The computer-implemented method of claim 1 wherein selecting the graphical image comprises selecting the graphical image of the clock face wherein the indicated time is represented by a position of clock hands, and wherein no numerals are displayed.

7. A computer-implemented method for generating a challenge/response test to determine if a computer user is a human, said method comprising steps of:
for each instance of the challenge/response test:
using a processor device configured to perform:
determining a time of day to present;
storing the time of day as an indicated time;
selecting a first graphical image representing a first analog clock face with an hour hand indicating an hour portion of the indicated time;
selecting a second graphical image representing a second analog clock face with a minute hand indicating a minute portion of the indicated time;
applying a distortion filter to the selected first and second graphical images to generate a dual distorted graphical image;
using an input/output interface configured to perform:
presenting the dual distorted graphical image to the computer user with a challenge to identify the indicated time shown; and
receiving input from the computer user; and
using the processor device to compare the input to the stored indicated time to determine if the computer user is human.

8. The computer-implemented method of claim 7, further comprising:
repeating the determining, storing, selecting, applying, presenting, receiving, and comparing steps when the input does not match the stored indicated time.

9. The computer-implemented method of claim 7, further comprising:
validating the computer user as human when the input matches the stored indicated time.

10. The computer-implemented method of claim 7 wherein selecting the first and second graphical images comprises selecting graphical images of the clock face wherein the indicated time is represented by clock hands pointing to Roman numerals.

11. The computer-implemented method of claim 7 wherein selecting the first and second graphical images comprises selecting graphical images of the clock face wherein the indicated time is represented by clock hands pointing to Arabic numerals.

12. The computer-implemented method of claim 7 wherein selecting the first and second graphical images comprises selecting graphical images of the clock face wherein the indicated time is represented by a position of clock hands, and wherein no numerals are displayed.

13. A system of generating a challenge/response test to determine if a computer user is human, said system comprising:
a memory comprising instructions;
a processor device operably coupled with the memory for executing the instructions, wherein said instructions, when executed, cause a computer to perform, for each instance of the challenge/response test:
determining a time of day to present;
storing the time of day as an indicated time;
selecting a graphical image representing an analog clock face with an indicated time;
applying a distortion filter to the graphical image to generate a distorted graphical image;
presenting the distorted graphical image to the computer user with a challenge to identify the indicated time shown;
receiving input from the computer user; and
comparing the input to the stored indicated time to determine if the computer user is human.

14. The system of claim 13 wherein the processor device further executes instructions of:
repeating the selecting, storing, applying, presenting, receiving, and comparing steps when the input does not match the stored indicated time.

15. The system of claim 13 wherein the processor device further executes instructions of:
validating the computer user as human when the input matches the stored indicated time.

16. The system of claim 13 further comprising a data store for storing the indicated time.

17. The system of claim 13 wherein the analog clock face comprises clock hands pointing at Roman numerals.

18. The system of claim 13 wherein the analog clock face comprises clock hands pointing at Arabic numerals.

19. The system of claim 13 wherein the analog clock face comprises no numerals and the indicated time is derived from a position of clock hands on said analog clock face.

20. The system of claim 19 wherein a position of twelve o'clock is represented by a notch on the analog clock face.
